(19) United States
(12) Patent Application Publication
(10) Pub. No.: US 2026/0168652 A1
(43) Pub. Date: Jun. 18, 2026

(54) LED LIGHT AND LED PRODUCT

(71) Applicant: JIANGXI YSING LIGHTING TECHNOLOGY CO., LTD, Pingxiang (CN)

(72) Inventor: MINGJIAN LIU, Dongguan (CN)

(21) Appl. No.: 19/534,810

(22) Filed: Feb. 10, 2026

Related U.S. Application Data
(63) Continuation of application No. PCT/CN2023/113137, filed on Aug. 15, 2023.

(51) Int. Cl. F21V 19/00; F21V 23/00; F21Y 113/13; F21Y 115/10

(52) U.S. Cl. CPC F21V 19/002; F21V 19/0025; F21V 23/005; F21Y 2113/13; F21Y 2115/10

(57) ABSTRACT

The present application discloses an LED lamp and an LED product. The LED lamp includes a light-emitting assembly, an insulating base, an encapsulation adhesive layer, and a plurality of conductive leads. The plurality of conductive leads are disposed on the insulating base. The light-emitting assembly is disposed on the conductive leads and is electrically connected to the conductive leads. The encapsulation adhesive layer is disposed on an exterior of the light-emitting assembly. The light-emitting assembly includes a drive chip and a plurality of light-emitting chip sets connected together in parallel or in series. The plurality of light-emitting chip sets are sequentially arranged along a length direction of the insulating base. Each light-emitting chip set comprises a blue chip, a green chip, and a red chip. The drive chip is electrically connected to the blue chip, the green chip, and the red chip, for driving the blue chip, the green chip, and the red chip to emit light.

### CROSS-REFERENCE TO RELATED APPLICATIONS

The application is a National Stage of International Application No. PCT/CN2023/113137, filed on Aug. 15, 2023, the entire contents of which are herein incorporated by reference.

### TECHNICAL FIELD

The present application relates to the field of LED technology, and in particular, to an LED lamp and an LED product.

### BACKGROUND

LED lamps are widely used in the lighting and display industries and have become one of the most notable products in recent years due to their advantages such as energy saving, power conservation, high efficiency, fast response time, long life cycle, mercury-free composition, and environmental friendliness.

LED products such as LED displays and LED light strips are generally composed of multiple LED lamps each having a blue chip, a green chip, and a red chip. With technological advancements, requirements for pixel pitch and other specifications of LED products are becoming increasingly stringent. Conventional LED lamps contain one blue chip, one green chip, and one red chip internally, and their size is relatively large, making it difficult to achieve small-pitch LED products, realize high-density installation at small pitches, and resulting in poor color effects or display quality.

### SUMMARY OF THE INVENTION

The present application provides an LED lamp and an LED product According to a first aspect of the present application, an LED lamp is provided, including a light-emitting assembly, an insulating base, an encapsulation adhesive layer, and a plurality of conductive leads;

in which the plurality of conductive leads are disposed on the insulating base, the light-emitting assembly is disposed on the conductive leads and is electrically connected to the conductive leads, and the encapsulation adhesive layer is disposed on an exterior of the light-emitting assembly;

the light-emitting assembly includes at least one drive chip and a plurality of light-emitting chip sets connected together in parallel or in series; the plurality of light-emitting chip sets are sequentially arranged along a layout direction of the insulating base; each light-emitting chip set includes a blue chip, a green chip, and a red chip; and at least one drive chip is electrically connected to connected to one or more of the blue chips, the green chips, and the red chips, for driving the blue chips, the green chips, and the red chips to emit light.

According to a second aspect of the present application, an LED product is provided, including the above-mentioned LED lamp, in which a plurality of the LED lamps are uniformly spaced.

It should be understood that the above general description and the following detailed description are exemplary and explanatory and do not limit the present application.

### BRIEF DESCRIPTION OF THE DRAWINGS

In order to illustrate the technical solutions of the embodiments of the present application more clearly, the accompanying drawings required for describing the embodiments will be briefly introduced below. Obviously, the drawings in the following description are some embodiments of the present application. For those skilled in the art, other drawings may be obtained based on these drawings without creative effort.

FIG. 1 is a schematic structural diagram of an LED lamp according to an embodiment of the present application;

FIG. 2 is a schematic structural diagram of the LED lamp in FIG. 1 from another perspective;

FIG. 3 is an exploded view of the LED lamp in FIG. 1;

FIG. 4 is a partial exploded view of the LED lamp in FIG. 1;

FIG. 5 is a schematic structural diagram of a light-emitting chip set in FIG. 1;

FIG. 6 is a schematic structural diagram of an insulating base in FIG. 1;

FIG. 7 is a schematic structural diagram of conductive leads in FIG. 1;

FIG. 8 is a schematic structural diagram of the conductive leads in FIG. 1 from another perspective;

FIG. 9 is a schematic structural diagram of an LED lamp according to an embodiment of the present application;

FIG. 10 is a schematic structural diagram of conductive leads in FIG. 9;

FIG. 11 is a schematic structural diagram of an LED lamp according to an embodiment of the present application;

FIG. 12 is a schematic structural diagram of an LED lamp according to an embodiment of the present application;

FIG. 13 is a schematic structural diagram of an LED lamp according to an embodiment of the present application;

FIG. 14 is a schematic structural diagram of an LED lamp according to an embodiment of the present application;

FIG. 15 is an exploded view of the LED lamp in FIG. 14;

FIG. 16 is a schematic structural diagram of an LED lamp according to an embodiment of the present application;

FIG. 17 is an exploded view of the LED lamp in FIG. 16;

FIG. 18 is a schematic structural diagram of an LED lamp according to an embodiment of the present application;

FIG. 19 is an exploded view of the LED lamp in FIG. 18.

### REFERENCE NUMERALS

10: light-emitting assembly; 11: drive chip; 12: light-emitting chip set; 121: red chip; 122: blue chip; 123: green chip;
20: conductive lead; 20a: through-hole structure; 20b: accommodation region; 21: ground pin; 211: first die bonding portion; 2111: second extension portion; 212: first soldering portion; 22: power pin; 221: second die bonding portion; 2211: third extension portion; 2212: fourth extension portion; 2213: fifth extension portion; 222: second soldering portion; 23: signal input pin; 231: third die bonding portion; 232: third soldering portion; 24: signal output pin; 241: fourth die bonding portion; 242: fourth soldering portion; 25: transition pin; 251: transition die bonding portion; 2511: first transition die bonding portion; 2512: second transition die bonding portion; 2513: third transition die bonding portion;
30: insulating base; 31: first end face;
40: encapsulation adhesive layer.

### DETAILED DESCRIPTION

The technical solutions in the embodiments of the present application will be described clearly and completely below with reference to the accompanying drawings in the embodiments of the present application. Obviously, the described embodiments are some embodiments of the present application, but not all. Based on the embodiments in the present application, all other embodiments obtained by a person of ordinary skill in the art without creative effort shall fall within the protection scope of the present application.

It should also be understood that the terminology used herein in the specification of the present application is for the purpose of describing particular embodiments and is not intended to be limiting of the present application. In the description of the present application, it should be understood that the terms such as “center,” “longitudinal,” “lateral,” “length,” “width,” “thickness,” “upper,” “lower,” “front,” “rear,” “left,” “right,” “vertical,” “horizontal,” “bottom,” “top,” “inner,” “outer,” “clockwise,” “counterclockwise,” etc., indicate orientations or positional relationships based on the orientations or positional relationships shown in the drawings, and are used for ease of description of the present application and simplification of the description, rather than indicating or implying that the apparatus or element referred to must have a specific orientation, be constructed and operated in a specific orientation, and therefore should not be construed as limiting the present application. Furthermore, the terms “first,” “second,” are used for descriptive purposes and are not to be construed as indicating or implying relative importance or implicitly indicating the number of indicated technical features. Thus, features defined with “first,” “second,” may explicitly or implicitly include one or more of the features. In the description of the present application, the meaning of “a plurality” is two or more, unless explicitly stated otherwise.

The present application provides an LED lamp and an LED product, which can integrate multiple light-emitting chip sets within a single LED lamp, enabling the single LED lamp to have multiple blue chips, multiple green chips, and multiple red chips emitting light. This facilitates high-density, small-pitch installation of LED products, thereby achieving more refined color effects, display quality, and resolution for LED products.

The present application designs an LED lamp and an LED product. The LED lamp includes a light-emitting assembly, an insulating base, an encapsulation adhesive layer, and a plurality of conductive leads. The light-emitting assembly has a drive chip and a plurality of light-emitting chip sets connected together in parallel or in series. The drive chip and the light-emitting chip sets are disposed on the conductive leads and are electrically connected to the conductive leads. The conductive leads are integrated on the insulating base, and the encapsulation adhesive layer is disposed on the exterior of the light-emitting assembly. As a result, multiple light-emitting chip sets may be integrated within a single LED lamp, and each light-emitting chip set includes a blue chip, a green chip, and a red chip. Therefore, the LED lamp may be applied to high-density and small-pitch LED products, thereby improving the color effects and display quality of LED products and making the resolution of LED products more refined.

The embodiments of the present application will be described in detail below with reference to the accompanying drawings. The embodiments and features in the embodiments may be combined with each other if there is no conflict.

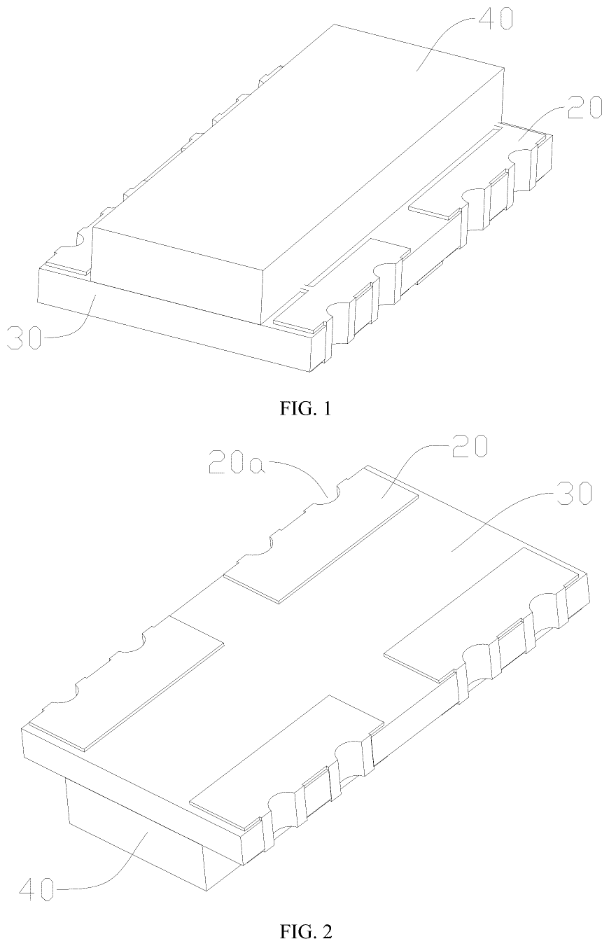

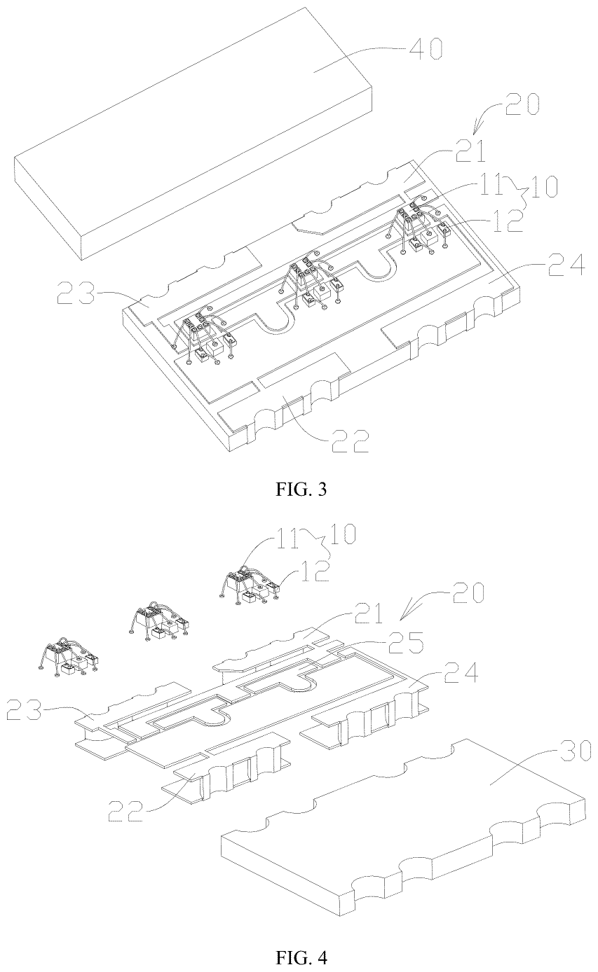

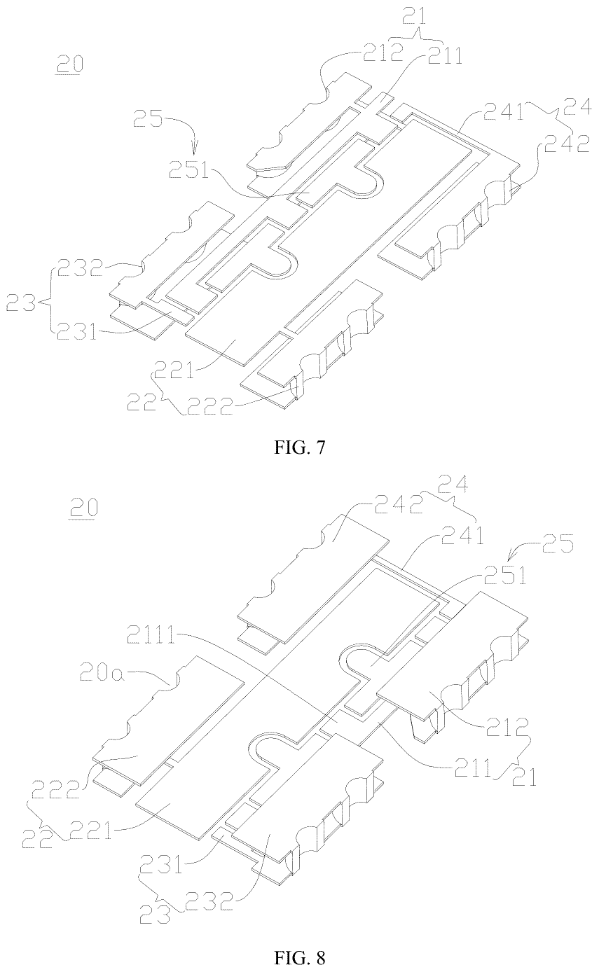

As shown in FIG. 1 to FIG. 19, according to a first aspect of the present application, an LED lamp is provided, including a light-emitting assembly 10, an insulating base 30, an encapsulation adhesive layer 40, and a plurality of conductive leads 20. The plurality of conductive leads 20 are disposed on the insulating base 30. The light-emitting assembly 10 is disposed on the conductive leads 20 and is electrically connected to the conductive leads 20. The encapsulation adhesive layer 40 is disposed on an exterior of the light-emitting assembly 10 to encapsulate the light-emitting assembly 10, which not only protects the light-emitting assembly 10 but also improves the light transmission effect of the light-emitting assembly 10.

The light-emitting assembly 10 includes a drive chip 11 and a plurality of light-emitting chip sets 12 connected together in parallel or in series. The plurality of light-emitting chip sets 12 are sequentially arranged along a layout direction of the insulating base 30. Each light-emitting chip set 12 includes a blue chip 122, a green chip 123, and a red chip 121. The drive chip 11 is electrically connected to the blue chip 122, the green chip 123, and the red chip 121, for driving the blue chip 122, the green chip 123, and the red chip 121 to emit light. The layout direction may be, but is not limited to, a length direction or a width direction of the insulating base 30.

In some embodiments, the number of light-emitting chip sets 12 is three, then the numbers of blue chips 122, green chips 123, and red chips 121 are also three. The three blue chips 122 may be connected together in series, or they may be connected together in parallel. Similarly, the three green chips 123 may be connected together in series, or they may be connected together in parallel. The three red chips 121 may be connected together in series, or they may be connected together in parallel. Furthermore, the blue chips 122, green chips 123, and red chips 121 may be connected together in series, or they may be connected together in parallel. The number of drive chips 11 may be one or more, which is not limited in the present application.

After adopting the above technical solutions, multiple blue chips 122, multiple green chips 123, and multiple red chips 121 are integrated within an LED lamp and uniformly spaced. As a result, the multiple blue chips 122, multiple green chips 123, and multiple red chips 121 within a single LED lamp can emit corresponding light, thereby generating diversified light colors and simulating color flashing effects. In addition, the LED lamp may be soldered onto wires or a carrier board to form an LED product such as a light-emitting strip or a display screen. The LED lamps may be connected in series or in parallel according to requirements, and different driving voltages may also be set, thereby realizing high-density and small-pitch design of LED products, improving the color effects and display quality of LED products and making the resolution of LED products more refined.

In some embodiments, as shown in FIG. 1 to FIG. 8, the insulating base 30 has a first end face 31. The conductive leads 20 have die bonding portions formed on the first end face 31 and soldering portions formed on a second end face. At least a part of the soldering portions have a through-hole structure 20a to enhance product soldering strength, such that part of soldering material may be accommodated in the through-hole structure 20a. The drive chip 11, blue chip 122, green chip 123, and red chip 121 are disposed on the die bonding portions and are electrically connected to the die bonding portions. The encapsulation adhesive layer 40 is disposed on an exterior of the die bonding portions.

After adopting the above technical solutions, because the soldering portions are formed on end faces of the insulating base 30 other than the first end face 31, the heat dissipation effect of the LED lamp can be effectively increased, and the soldering area and firmness of the soldering portions can also be increased.

The size of the die bonding portions is determined based on the number of the multiple light-emitting chip sets 12 and the spacing between the multiple light-emitting chips. Therefore, integrating the multiple light-emitting chip sets 12 on the die bonding portions in the present application can not only increase the heat dissipation effect of the light-emitting chips but also ensure the light-emitting effect of the LED lamp, making it suitable for various uniform lighting scenarios.

In some embodiments, the conductive leads 20 include a power pin 22 and a ground pin 21. The drive chip 11 is electrically connected to the power pin 22 and the ground pin 21. The blue chip 122, the green chip 123, and the red chip 121 are electrically connected to the power pin 22 and the drive chip 11. The blue chip 122, the green chip 123, and the red chip 121 are disposed on the insulating base 30 and equally spaced along the layout direction of the insulating base 30, to realize the high-density and small-pitch LED lamp.

In some embodiments, the drive chip 11 is disposed on at least one of the power pin 22 and the ground pin 21. The light-emitting chip set 12 may be disposed on the power pin 22 or the ground pin 21, or may be disposed on other conductive leads 20 besides the power pin 22 and the ground pin 21.

In some embodiments, the light-emitting chip set 12 is disposed on at least one of the power pin 22 and the ground pin 21. The drive chip 11 may be disposed on the power pin 22 or the ground pin 21, or may be disposed on other conductive leads 20 besides the power pin 22 and the ground pin 21.

In some embodiments, the drive chip 11 is disposed on the ground pin 21, and the light-emitting chip set 12 is disposed on the power pin 22.

A second input terminal of the drive chip 11 is electrically connected to the ground pin 21. The drive chip 11 and a first input terminal of the light-emitting chip set 12 is electrically connected to the power pin 22. A second input terminal of the light-emitting chip set 12 is connected to the drive chip 11. That is, the light-emitting chips in the light-emitting chip set 12 are connected together in parallel and can also be controlled by the drive chip 11 to emit light.

Alternatively, a first input terminal of the drive chip 11 is electrically connected to the power pin 22. A second input terminal of the drive chip 11 is electrically connected to the ground pin 21. First and second input terminals of the light-emitting chip set 12 are connected to the drive chip 11. That is, the light-emitting chips in the light-emitting chip set 12 are connected together in series and obtain operating voltage through the drive chip 11, and can also be controlled by the drive chip 11 to emit light.

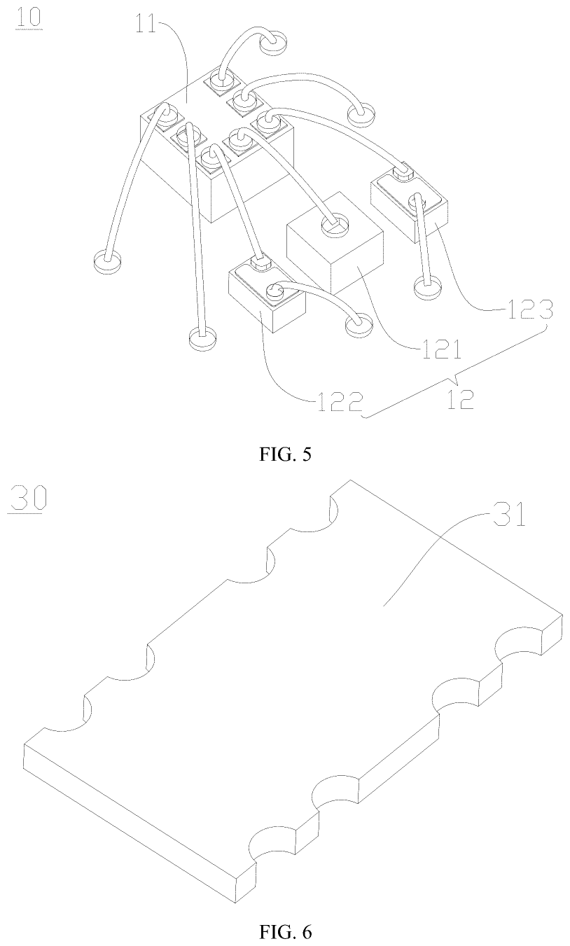

In some embodiments, as shown in FIG. 4 and FIG. 5, the numbers of drive chips 11 and light-emitting chip sets 12 are both three, meaning the numbers of blue chips 122, green chips 123, and red chips 121 are three. The three blue chips 122, three green chips 123, and three red chips 121 are correspondingly connected to the three drive chips 11 to form three light-emitting groups. That is, each drive chip 11 can control one blue chip 122, one green chip 123, and one red chip 121. Meanwhile, the blue chips 122, green chips 123, red chips 121, and drive chips 11 are connected together in parallel, and the three light-emitting groups are equally spaced in parallel.

In some embodiments, as shown in FIG. 5 and FIG. 10, the numbers of drive chips 11 and light-emitting chip sets 12 are both four, meaning the numbers of blue chips 122, green chips 123, and red chips 121 are four. The four blue chips 122, four green chips 123, and four red chips 121 are correspondingly connected to the four drive chips 11 to form four light-emitting groups. That is, each drive chip 11 can control one blue chip 122, one green chip 123, and one red chip 121. Meanwhile, the blue chips 122, green chips 123, red chips 121, and drive chips 11 are connected together in parallel, and the four light-emitting groups are equally spaced in parallel.

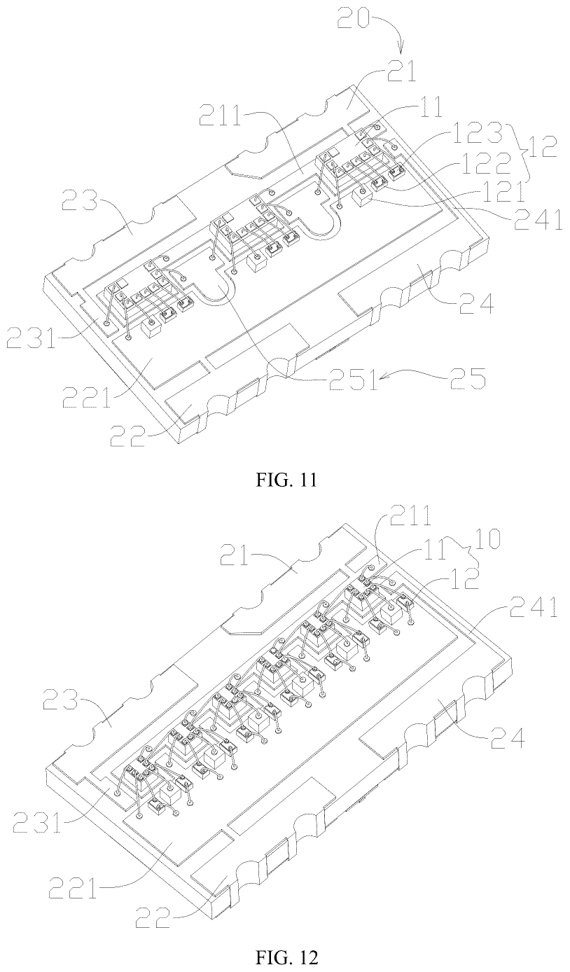

In some embodiments, as shown in FIG. 11, the numbers of drive chips 11 and light-emitting chip sets 12 are both three, meaning the numbers of blue chips 122, green chips 123, and red chips 121 are three. The three blue chips 122, three green chips 123, and three red chips 121 are correspondingly connected to the three drive chips 11 to form three light-emitting groups. That is, each drive chip 11 can control one blue chip 122, one green chip 123, and one red chip 121. Meanwhile, the blue chips 122, green chips 123, and red chips 121 are connected together in series via the drive chips 11, and the three light-emitting groups are equally spaced in parallel.

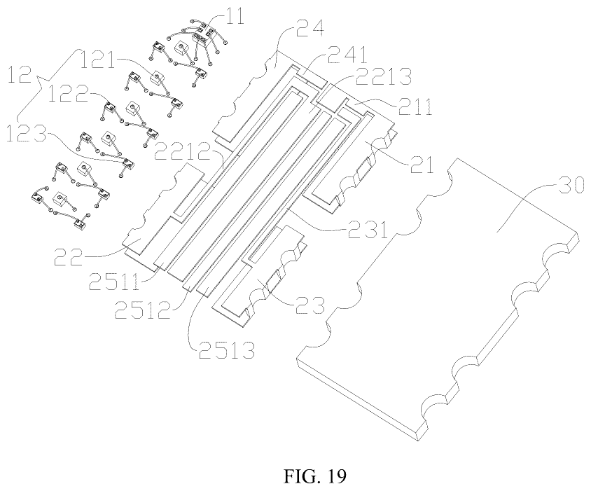

In some embodiments, as shown in FIG. 14 and FIG. 19, the number of drive chips 11 is one, and the number of light-emitting chip sets 12 is at least two, meaning the numbers of blue chips 122, green chips 123, and red chips 121 are at least two. The at least two blue chips 122 are connected together in series to form a first light-emitting group. The at least two red chips 121 are connected together in series to form a second light-emitting group. The at least two green chips 123 are connected together in series to form a third light-emitting group. The first light-emitting group, the second light-emitting group, and the third light-emitting group are connected together in parallel and are electrically connected to the drive chip 11, so that the drive chip 11 can control the first light-emitting group, the second light-emitting group, and the third light-emitting group to emit light.

In some embodiments, as shown in FIG. 14, the number of drive chips 11 is one, and the number of light-emitting chip sets 12 is two, meaning the numbers of blue chips 122, green chips 123, and red chips 121 are two. One blue chip 122, one green chip 123, and one red chip 121 are located on one end of the insulating base 30 in the length direction. Another blue chip 122, another green chip 123, and another red chip 121 are located on the other end of the insulating base 30 in the length direction. The drive chip 11 is disposed on one end of the insulating base 30 in the length direction and is electrically connected to the blue chips 122, green chips 123, and red chips 121, for controlling the two blue chips 122, two green chips 123, and two red chips 121 to emit light.

In some embodiments, the LED lamp are formed by CHIP-type packaging technology. That is, a corresponding circuit is first laid out on a packaging substrate, then the drive chips 11 and light-emitting chip sets 12 are equally spaced, and finally electrical connections are made.

In some embodiments, the ground pin 21 includes a first soldering portion 212 and a first die bonding portion 211. The power pin 22 includes a second soldering portion 222 and a second die bonding portion 221. A portion of the second soldering portion 222 and a portion of the first soldering portion 212 are disposed on opposite ends of the insulating base 30. The drive chip 11 is disposed on the first die bonding portion 211. The light-emitting chip set 12 is disposed on the second die bonding portion 221. In this embodiment, the size of the first die bonding portion 211 corresponds to the number and density of the first die bonding portions 211. The size of the second die bonding portion 221 corresponds to the number and density of the light-emitting chip sets 12. So that heat generated during the operation of the drive chip 11 and light-emitting chip set 12 can be transferred to the first soldering portion 212 and the second soldering portion 222 via the first die bonding portion 211 and the second die bonding portion 221, respectively, and then dissipated to the connected circuit board or the external environment via the first soldering portion 212 and the second soldering portion 222.

In some embodiments, the conductive lead 20 further includes a signal input pin 23 and a signal output pin 24. The signal input pin 23 and the signal output pin 24 are respectively electrically connected to a signal input terminal and a signal output terminal of the drive chip 11. Alternatively, the signal input terminal of one drive chips 11 and the signal output terminal of adjacent drive chip 11 are electrically connected. The signal input pin 23 and the signal output pin 24 are electrically connected to the signal input terminal and the signal output terminal of drive chips 11 located at two ends of the insulating base 30, enabling the signal input pin 23 and the signal output pin 24 to input or output control signals of the light-emitting chip set 12 to the drive chips 11.

In some embodiments, the signal input pin 23 and the ground pin 21 are disposed on one end of the insulating base 30. The signal output pin 24 and the power pin 22 are disposed on the other end of the insulating base 30. That is, the signal input pin 23 and the ground pin 21 are located on one end of the insulating base 30, and the signal output pin 24 and the power pin 22 are located on the opposite end of the insulating base 30, improving the heat dissipation effect of the ground pin 21 and the power pin 22 during operation.

In some embodiments, the signal input pin 23 includes a third soldering portion 232 and a third die bonding portion 231. The signal output pin 24 includes a fourth soldering portion 242 and a fourth die bonding portion 241. A portion of the third soldering portion 232 is disposed on a side adjacent to the first soldering portion 212 and opposite to the second soldering portion 222. A portion of the fourth soldering portion 242 is disposed on a side adjacent to the second soldering portion 222 and opposite to the first soldering portion 212. The third die bonding portion 231 is connected to the third soldering portion 232 and is located on one side of the first die bonding portion 211. The fourth die bonding portion 241 is connected to the fourth soldering portion 242 and is located on one side of the second die bonding portion 221. The signal input terminal and the signal output terminal of the drive chips 11 at the two ends of the insulating base 30 are electrically connected to the third die bonding portion 231 and the fourth die bonding portion 241, respectively.

In some embodiments, as shown in FIG. 1 to FIG. 13, the numbers of drive chips 11 and light-emitting chip sets 12 are at least two. The at least two light-emitting chip sets 12 are correspondingly connected to the at least two drive chips 11 and are combined together in parallel, so that each drive chip 11 can correspondingly control each connected light-emitting chip set 12 to emit light.

In some embodiments, the conductive leads 20 further include at least one transition pin 25. The transition pin 25 has a transition die bonding portion 251. The transition die bonding portion 251 is disposed between two adjacent drive chips 11, for electrically connecting the signal input terminal of one drive chip 11 to the signal output terminal of another drive chip 11, so as to reduce the length of bonding wires on the drive chips 11, lower the packaging difficulty of the LED lamp, and simplify the structure of the LED lamp.

In some embodiments, the second die bonding portion 221 and the fourth die bonding portion 241 are disposed at two sides of the second die bonding portion 221 and the first die bonding portion 211. The transition die bonding portion 251 is disposed between the second die bonding portion 221 and the first die bonding portion 211.

In some embodiments, the first die bonding portion 211 has a first extension portion and at least one second extension portion 2111 perpendicular to the first extension portion. The first extension portion and the second die bonding portion 221 extend along the length direction of the insulating base 30. The second extension portion 2111 extends towards the direction of the second die bonding portion 221, an accommodation region 20b is disposed between the second extension portion and the second die bonding portion. The transition die bonding portion 251 is disposed in the accommodation region 20b, so that the signal input terminal and signal output terminal of adjacent two drive chips 11 can be electrically connected via the transition die bonding portion 251. This reduces the length of bonding wires, thereby preventing the bonding wires from breaking during packaging. Additionally, the signal input terminal and signal output terminal of adjacent two drive chips 11 can be directly electrically connected by bonding wires, which is not limited in the present application.

In some embodiments, as shown in FIG. 1 to FIG. 8, the numbers of drive chips 11 and light-emitting chip sets 12 are three, and they are equally spaced along the length direction of the insulating base 30. The drive chips 11 are disposed on the second extension portions 2111. The transition die bonding portion 251 is disposed between adjacent two second extension portions 2111.

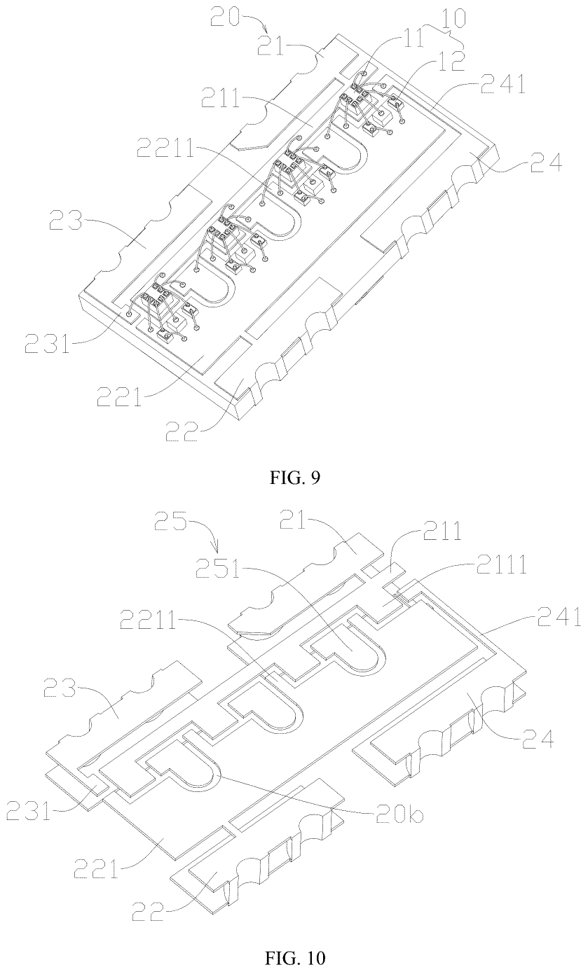

In some embodiments, as shown in FIG. 9 and FIG. 10, the second die bonding portion 221 has a third extension portion 2211 extending towards the first extension portion. The third extension portion 2211 is disposed adjacent to the second extension portion 2111. A first input terminal of the drive chip 11 is connected to the third extension portion 2211 via a bonding wire. The transition die bonding portion 251 is disposed in the accommodation region 20b formed between the third extension portion 2211 and the second extension portion 2111.

In some embodiments, the numbers of drive chips 11 and light-emitting chip sets 12 are four, and they are equally spaced along the length direction of the insulating base 30. The drive chips 11 are disposed on the second extension portions 2111. The transition die bonding portion 251 is disposed between the third extension portion 2211 and the second extension portion 2111.

In some embodiments, as shown in FIG. 11, the numbers of drive chips 11 and light-emitting chip sets 12 are at least two. The at least two light-emitting chip sets 12 are correspondingly connected to the at least two drive chips 11 and are combined together in parallel, and the blue chip 122, green chip 123, and red chip 121 on each light-emitting chip set 12 are connected to the drive chip 11 in series.

In some embodiments, the numbers of drive chips 11 and light-emitting chip sets 12 are three, meaning the numbers of blue chips 122, green chips 123, and red chips 121 are three. The three blue chips 122, three green chips 123, and three red chips 121 are correspondingly connected to the three drive chips 11 to form three light-emitting groups. That is, each drive chip 11 can control one blue chip 122, one green chip 123, and one red chip 121. Meanwhile, the blue chips 122, green chips 123, and red chips 121 are connected together in series via the drive chips 11, meaning both ends of the blue chip 122, green chip 123, and red chip 121 are electrically connected to the drive chip 11, and the three light-emitting groups are equally spaced in parallel.

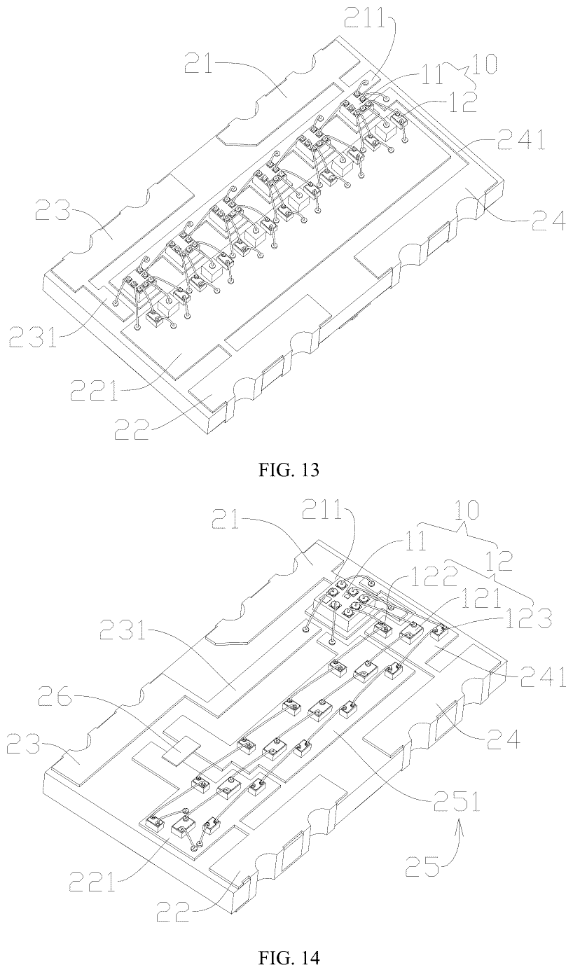

In some embodiments, as shown in FIG. 12 and FIG. 13, the numbers of drive chips 11 and light-emitting chip sets 12 are six, meaning the numbers of blue chips 122, green chips 123, and red chips 121 are six. The six blue chips 122, six green chips 123, and six red chips 121 are correspondingly connected to the six drive chips 11 to form six light-emitting groups. That is, each drive chip 11 can control one blue chip 122, one green chip 123, and one red chip 121. Meanwhile, the blue chips 122, green chips 123, and red chips 121 are connected together in parallel, and the signal input terminal and signal output terminal of adjacent two drive chips 11 among the six drive chips 11 can also be directly electrically connected by bonding wires.

In some embodiments, as shown in FIG. 14 to FIG. 19, the number of drive chips 11 is one, and the number of light-emitting chip sets 12 is at least two. The two light-emitting chip sets 12 are connected to the drive chip 11 in series, so that the drive chip 11 can control the light-emitting chips connected in series to emit light.

In some embodiments, the blue chips 122 on the multiple light-emitting chip sets are connected in series. The green chips 123 on the multiple light-emitting chip sets are connected in series. The red chips 121 on the multiple light-emitting chip sets are connected in series. The blue chips 122, green chips 123, and red chips 121 of the three colors are arranged in parallel.

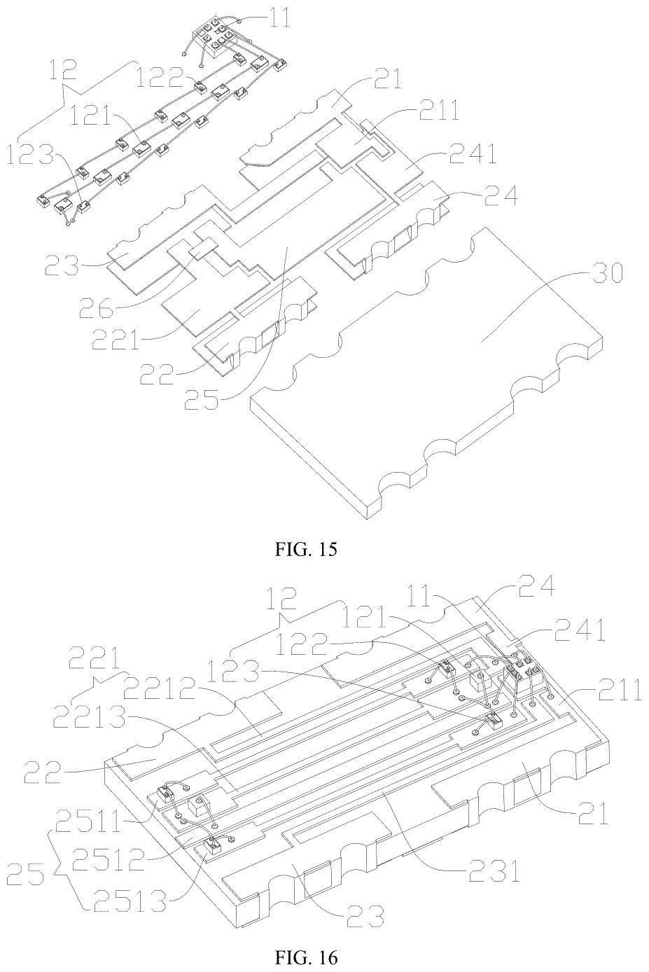

In some embodiments, as shown in FIG. 14 and FIG. 15, the number of light-emitting chip sets 12 is six. The six blue chips 122 are connected in series. The six green chips 123 on the light-emitting chip sets are connected in series. The six red chips 121 on the light-emitting chip sets are connected in series. The six blue chips 122 connected in series, the six green chips 123 connected in series, and the six red chips 121 connected in series are arranged in parallel.

In some embodiments, the conductive leads 20 further include at least one transition pin 25. The transition pin 25 has a transition die bonding portion 251. The transition die bonding portion 251 is disposed between at least two adjacent die bonding portions among the first die bonding portion 211, the second die bonding portion 221, the third die bonding portion 231, and the fourth die bonding portion 241. As a result, at least one of the first die bonding portion 211, the second die bonding portion 221, the third die bonding portion 231, and the fourth die bonding portion 241 can be electrically connected to the drive chip 11 and/or the light-emitting chip set 12 via the transition die bonding portion 251.

In some embodiments, a protective device 26 is connected between the transition pin 25 and the power pin 22, for protecting devices. The protective device 26 may be a resistor and/or a diode, etc., which can serve functions such as voltage division and current limiting to protect the devices. The devices include, but are not limited to, the drive chip 11 and the light-emitting chip set 12.

In some embodiments, at least part of the light-emitting chip sets 12 are disposed on the transition die bonding portion and the signal input pin 23, and the remaining part of the light-emitting chip sets 12 are disposed on the power pin 22 and are electrically connected to the power pin 22, allowing the light-emitting chip sets 12 to be disposed on the insulating base 30 and equally spaced along the layout direction of the insulating base 30.

In some embodiments, the second die bonding portion 221 extends from the power pin 22 and then extends vertically towards one end of the insulating base 30 to form a fourth extension portion 2212. The fourth extension portion 2212 extends towards the other end of the insulating base 30 to form a fifth extension portion 2213. The fifth extension portion 2213 is parallel to the fourth extension portion 2212. The drive chip 11 is disposed at a junction of the fourth extension portion 2212 and the fifth extension portion 2213. At least part of the light-emitting chip sets 12 are disposed on the fifth extension portion 2213.

In some embodiments, the conductive leads 20 further include three transition pins 25. Each transition pin 25 has a transition die bonding portion 251. The three transition die bonding portions 251 are arranged on the insulating base 30 at intervals. The drive chip 11 is correspondingly connected to the blue chip 122, the green chip 123, and the red chip 121 through the three transition die bonding portions 251.

In some embodiments, the transition pins 25 include a first transition pin 25, a second transition pin 25, and a third transition pin 25. The first transition pin 25 has a first transition die bonding portion 2511. The second transition pin 25 has a second transition die bonding portion 2512. The third transition pin 25 has a third transition die bonding portion 2513. The first transition die bonding portion 2511 is disposed between the fifth extension portion 2213 and the fourth extension portion 2212. The second transition die bonding portion 2512 is disposed between the fifth extension portion 2213 and the third transition die bonding portion 2513. The third transition die bonding portion 2513 is disposed adjacent to the third die bonding portion 231.

In some embodiments, one of the blue chip 122 and the green chip 123 is disposed on one of the transition die bonding portions 251. The other of the blue chip 122 and the green chip 123 is disposed on another of the transition die bonding portions 251. The red chip 121 is disposed on the fifth extension portion 2213 and is connected to the drive chip 11 through the last one of the transition die bonding portions 251.

In some embodiments, the blue chip 122 is disposed on the first transition die bonding portion 2511 and is electrically connected to the fifth extension portion 2213. The green chip 123 is disposed on the third transition die bonding portion 2513 and is electrically connected to the fifth extension portion 2213. The red chip 121 is disposed on the fifth extension portion 2213 and is electrically connected to the fifth extension portion 2213. The blue chip 122 is connected to the drive chip 11 via the first transition die bonding portion 2511. The green chip 123 is connected to the drive chip 11 via the third transition die bonding portion 2513. The red chip 121 is connected to the drive chip 11 via the second transition die bonding portion 2512.

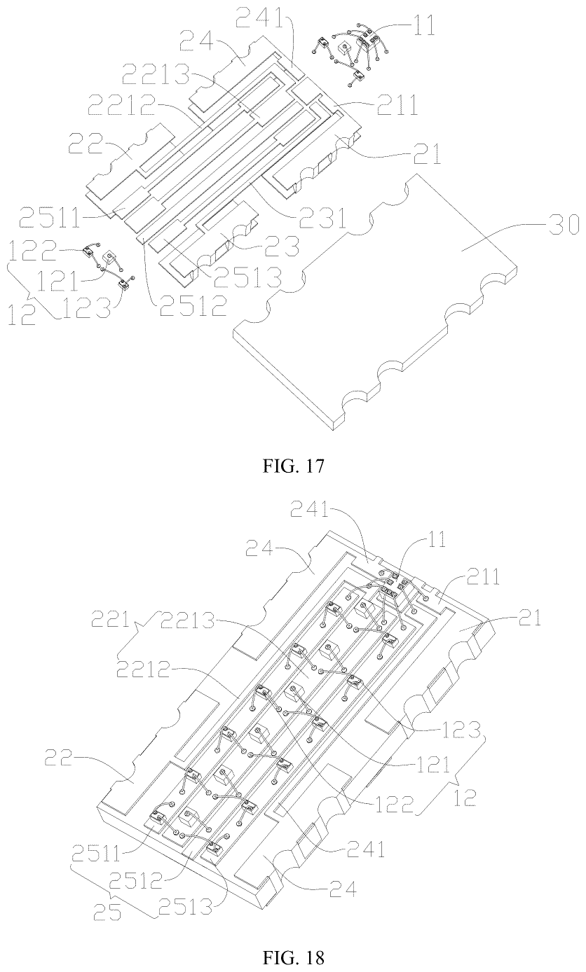

In some embodiments, as shown in FIG. 16 to FIG. 17, the number of light-emitting chip sets 12 is two. The two blue chips 122 are disposed at two ends of one of the transition die bonding portions 251. The two green chips 123 are disposed on another of the transition die bonding portions 251. The two red chips 121 are disposed at two ends of the fifth extension portion 2213.

In some embodiments, the blue chips 122 are disposed at two ends of the first transition die bonding portion 2511 and are electrically connected to the fifth extension portion 2213. The green chips 123 are disposed at two ends of the third transition die bonding portion 2513 and are electrically connected to the fifth extension portion 2213. The red chips 121 are disposed at two ends of the fifth extension portion 2213 and are electrically connected to the fifth extension portion 2213. The blue chips 122 are connected to the drive chip 11 via the first transition die bonding portion 2511. The green chips 123 are connected to the drive chip 11 via the third transition die bonding portion 2513. The red chips 121 are connected to the drive chip 11 via the second transition die bonding portion 2512.

In some embodiments, as shown in FIG. 18 to FIG. 19, the number of light-emitting chip sets 12 is at least three. The at least three blue chips 122 are equally spaced along a length direction of one of the transition die bonding portions 251. The at least three green chips 123 are equally spaced along a length direction of another of the transition die bonding portions 251. The at least three red chips 121 are equally spaced along a length direction of the fourth extension portion 2212.

In some embodiments, the number of light-emitting chip sets 12 is six. The six blue chips 122 are equally spaced along the length direction of the first transition die bonding portion 2511 and are electrically connected to the fifth extension portion 2213. The six green chips 123 are equally spaced along the length direction of the third transition die bonding portion 2513 and are electrically connected to the fifth extension portion 2213. The six red chips 121 are equally spaced along the length direction of the fifth extension portion 2213 and are electrically connected to the fifth extension portion 2213. The blue chips 122 are connected to the drive chip 11 via the first transition die bonding portion 2511. The green chips 123 are connected to the drive chip 11 via the third transition die bonding portion 2513. The red chips 121 are connected to the drive chip 11 via the second transition die bonding portion 2512.

As shown in FIG. 1 to FIG. 19, according to a second aspect of the present application, an LED product is also provided, including the above-mentioned LED lamp, where a plurality of the LED lamps are equally spaced, thereby realizing high-density and small-pitch design of LED products, improving the color effects and display quality of LED products and making the resolution of LED products more refined. The LED product includes, but is not limited to, displays, LED light strips, etc.

In the description of the present application, it should be noted that, the terms “mount,” “connect,” “link,” should be understood broadly. In some embodiments, it may be a fixed connection, a detachable connection, or an integral connection. It may be a mechanical connection or an electrical connection. It may be a direct connection, an indirect connection through an intermediary, or an internal connection between two elements or an interaction relationship between two elements. For a person of ordinary skill in the art, the meanings of the above terms in the present application may be understood based on specific situations.

In the present application, a first feature being “on” or “under” a second feature may include that the first and second features are in direct contact, or may include that the first and second features are not in direct contact but are in contact through additional features between them. Furthermore, a first feature being “on,” “above,” or “over” a second feature includes the first feature being directly above or obliquely above the second feature, or merely indicates that a horizontal height of the first feature is higher than that of the second feature. A first feature being “under,” “below,” or “beneath” a second feature includes the first feature being directly below or obliquely below the second feature, or merely indicates that a horizontal height of the first feature is lower than that of the second feature.

The foregoing disclosure provides many different embodiments or examples for implementing different structures of the present application. To simplify the disclosure of the present application, components and configurations of specific examples are described above. They are examples and are not intended to limit the present application. Furthermore, the present application may repeat reference numerals and/or reference letters in different examples. Such repetition is for the purpose of simplification and clarity and does not in itself indicate a relationship between the various discussed embodiments and/or configurations. Furthermore, the present application provides examples of various specific processes and materials, but a person of ordinary skill in the art may recognize the applicability of other processes and/or the use of other materials.

In the description of the specification, descriptions referring to terms such as “one embodiment,” “some embodiments,” “an exemplary embodiment,” “an example,” “a specific example,” or “some examples” mean that specific features, structures, materials, or characteristics described in connection with the embodiment or example are included in at least one embodiment or example of the present application. In this specification, schematic references to the above terms do not necessarily refer to the same embodiment or example. Moreover, the described specific features, structures, materials, or characteristics may be combined in any suitable manner in any one or more embodiments or examples.

What is claimed is:

1. An LED lamp, comprising: a light-emitting assembly, an insulating base, an encapsulation adhesive layer, and a plurality of conductive leads;
wherein the plurality of conductive leads are disposed on the insulating base, the light-emitting assembly is disposed on the conductive leads and is electrically connected to the conductive leads, and the encapsulation adhesive layer is disposed on an exterior of the light-emitting assembly;
the light-emitting assembly comprises at least one drive chip and a plurality of light-emitting chip sets connected together in parallel or in series; the plurality of light-emitting chip sets are sequentially arranged along a layout direction of the insulating base; each light-emitting chip set comprises a blue chip, a green chip, and a red chip; and at least one drive chip is electrically connected to one or more of the blue chips, the green chips, and the red chips, for driving the blue chips, the green chips, and the red chips to emit light.

2. The LED lamp according to claim 1, wherein the insulating base has a first end face, each conductive lead has a die bonding portion formed on the first end face and a soldering portion formed on a second end face; the drive chip, the blue chip, the green chip, and the red chip are disposed on the die bonding portion and are electrically connected to the die bonding portion; and at least a part of the soldering portion has a through-hole structure.

3. The LED lamp according to claim 1, wherein the conductive leads comprise a power pin and a ground pin; the drive chip is electrically connected to the power pin and the ground pin; the blue chip, the green chip, and the red chip are electrically connected to the power pin and the drive chip; the blue chip, the green chip, and the red chip are disposed on the insulating base and equally spaced along the layout direction of the insulating base.

4. The LED lamp according to claim 3, wherein the ground pin comprises a first soldering portion and a first die bonding portion, the power pin comprises a second soldering portion and a second die bonding portion; a portion of the second soldering portion and a portion of the first soldering portion are disposed on opposite ends of the insulating base, the drive chip is disposed on the first die bonding portion, and the light-emitting chip set is disposed on the second die bonding portion.

5. The LED lamp according to claim 3, wherein the conductive leads further comprise a signal input pin and a signal output pin;
the signal input pin and the signal output pin are respectively electrically connected to a signal input terminal and a signal output terminal of the drive chip; or, a signal input terminal of one drive chip is electrically connected to a signal output terminal of an adjacent drive chip, the signal input pin and the signal output pin are electrically connected to the signal input terminal and the signal output terminal of drive chips at two ends of the insulating base, respectively.

6. The LED lamp according to claim 5, wherein the signal input pin and the ground pin are disposed on one end of the insulating base, and the signal output pin and the power pin are disposed on the other end of the insulating base.

7. The LED lamp according to claim 5, wherein a number of the drive chips and a number of the light-emitting chip sets are at least two, the at least two light-emitting chip sets are correspondingly connected to the at least two drive chips and are combined together in parallel, so that each drive chip can correspondingly control connected light-emitting chip set to emit light.

8. The LED lamp according to claim 7, wherein the conductive leads further comprise at least one transition pin, the transition pin has a transition die bonding portion; and the transition die bonding portion is disposed between the two drive chips, for electrically connecting the signal input terminal of one of the drive chips to the signal output terminal of another of the drive chips.

9. The LED lamp according to claim 8, wherein the signal input pin comprises a third die bonding portion, the signal output pin comprises a fourth die bonding portion, the third die bonding portion and the fourth die bonding portion are disposed at two sides of a second die bonding portion and the first die bonding portion, and the transition die bonding portion is disposed between the third die bonding portion and the fourth die bonding portion.

10. The LED lamp according to claim 9, wherein the first die bonding portion has a first extension portion and at least one second extension portion connected to the first extension portion; the first extension portion and the second die bonding portion extend along a length direction of the insulating base; the second extension portion extends towards a direction of the second die bonding portion, an accommodation region is disposed between the second extension portion and the second die bonding portion, and the transition die bonding portion is disposed in the accommodation region.

11. The LED lamp according to claim 10, wherein the second die bonding portion has a third extension portion extending towards the first extension portion, the third extension portion is disposed adjacent to the second extension portion, and a first input terminal of the drive chip is connected to the third extension portion via a bonding wire.

12. The LED lamp according to claim 6, wherein a number of the drive chips is one, a number of the light-emitting chip sets is at least two, the two light-emitting chip sets are connected to the drive chip in series, so that the drive chip can control the light-emitting chip sets connected in series to emit light.

13. The LED lamp according to claim 6, wherein a number of the drive chips and a number of the light-emitting chip sets are at least two, the at least two light-emitting chip sets are correspondingly connected to the at least two drive chips and are combined together in parallel; and the blue chip, the green chip, and the red chip on each light-emitting chip set are connected to the drive chip in series.

14. The LED lamp according to claim 12, wherein the blue chips on the plurality of light-emitting chip sets are connected in series, the green chips on the plurality of light-emitting chip sets are connected in series, the red chips on the plurality of light-emitting chip sets are connected in series; and the blue chips, the green chips, and the red chips are arranged in parallel.

15. The LED lamp according to claim 1, wherein the conductive leads further comprise at least one transition pin, the transition pin has a transition die bonding portion; and the transition die bonding portion is disposed between at least two adjacent die bonding portions among a first die bonding portion, a second die bonding portion, a third die bonding portion, and a fourth die bonding portion.

16. The LED lamp according to claim 15, wherein a protective device is connected between the transition pin and a power pin.

17. The LED lamp according to claim 16, wherein at least part of the light-emitting chip sets are disposed on the transition die bonding portion and a signal input pin, and remaining part of the light-emitting chip sets are disposed on the power pin and are electrically connected to the power pin.

18. The LED lamp according to claim 12, wherein a second die bonding portion extends from the power pin and extends vertically towards one end of the insulating base to form a fourth extension portion, the fourth extension portion extends towards the other end of the insulating base to form a fifth extension portion, the fifth extension portion is parallel to the fourth extension portion, the drive chip is disposed at a junction of the fourth extension portion and the fifth extension portion, and at least part of the light-emitting chip sets are disposed on the fifth extension portion.

19. The LED lamp according to claim 18, wherein the conductive leads further comprise three transition pins, each transition pin has a transition die bonding portion, the three transition die bonding portions are arranged on the insulating base at intervals; and the drive chip is correspondingly connected to the blue chip, the green chip, and the red chip through the three transition die bonding portions.

20. An LED product, comprising a plurality of LED lamps according to claim 1, wherein the plurality of LED lamps are uniformly spaced.
